(19) United States
(12) Patent Application Publication
(10) Pub. No.: US 2026/0280653 A1
(43) Pub. Date: Sep. 17, 2026

(54) MACHINE LEARNING-BASED CHANNEL STATE INFORMATION TRANSMISSION TECHNIQUE

(71) Applicant: POSTECH RESEARCH AND BUSINESS DEVELOPMENT FOUNDATION, Pohang-si (KR)

(72) Inventors: Yo-Seb JEON, Pohang-si (KR); Junyong SHIN, Pohang-si (KR)

(21) Appl. No.: 19/669,207

(22) Filed: May 6, 2026

Related U.S. Application Data
(63) Continuation-in-part of application No. PCT/KR2024/014260, filed on Sep. 23, 2024.

(30) Foreign Application Priority Data
Nov. 13, 2023 (KR) 10-2023-0156766
Jan. 10, 2024 (KR) 10-2024-0003932

(51) Int. Cl. H04B 7/06; H04B 7/0456

(52) U.S. Cl. CPC H04B 7/0626; H04B 7/0456

(57) ABSTRACT

A method for a first communication device to transmit channel state information to a second communication device in a wireless communication system. The first communication device uses an encoder neural network to generate at least one latent vector from first channel state information for a wireless link from the second communication device, separately quantizes a magnitude and a direction of each latent vector to generate magnitude information and direction information, and transmits second channel state information including the magnitude information and the direction information to the second communication device. A codebook used for the quantization may be configured based on codebook configuration information received from the second communication device.

### CROSS-REFERENCE TO RELATED APPLICATIONS

This application is a continuation-in-part of International Application No. PCT/KR2024/014260, filed on Sep. 23, 2024, which claims priority to Korean Patent Application No. 10-2023-0156766, filed on Nov. 13, 2023, and Korean Patent Application No. 10-2024-0003932, filed on Jan. 10, 2024, the disclosures of which are incorporated herein by reference in their entirety.

### FIELD OF THE INVENTION

The present disclosure relates to a channel state information transmission technique, and more particularly, to a machine learning-based channel state information transmission technique.

### BACKGROUND OF THE INVENTION

In wireless communication systems, channel state information feedback is used in various techniques such as Adaptive Modulation and Coding, MIMO precoding, and Beamforming.

In order for these techniques to achieve excellent performance or to increase the transmission efficiency of the overall system, the information contained in the channel state information feedback should be accurate, and it may be desirable that the overhead of the channel state information feedback is not large.

For example, in order for a base station to obtain the performance benefits of massive-MIMO, accurate channel state information is needed. However, because a massive MIMO system has a very large channel state information dimension, it may have the limitation of requiring a significant amount of feedback overhead.

Therefore, an efficient channel state information transmission technique may be needed.

### SUMMARY OF THE INVENTION

According to one aspect of the present disclosure, there is provided a method in which a first communication device transmits channel state information to a second communication device, the method comprising: inputting first channel state information—including channel state information for a wireless link from the second communication device to the first communication device—into an encoder neural network to generate at least one latent vector; for each of the at least one latent vector, separately quantizing a magnitude and a direction of the corresponding latent vector to generate magnitude information and direction information; and transmitting, to the second communication device, second channel state information including the magnitude information and the direction information corresponding to each of the at least one latent vector.

In some embodiments, the step of generating the direction information may comprise, for each of the at least one latent vector, selecting a codebook vector closest to the corresponding latent vector from among a plurality of codebook vectors included in a pre-configured codebook, and generating the direction information of the corresponding latent vector based on the selected codebook vector.

In some embodiments, the direction information may include an identifier of the selected codebook vector.

In some embodiments, the plurality of codebook vectors may comprise unit norm vectors.

In some embodiments, the step of generating the direction information may comprise: normalizing each of the at least one latent vector so that its magnitude becomes 1; and for each of the normalized latent vectors, selecting a codebook vector closest to the corresponding normalized latent vector from among the plurality of codebook vectors, and generating the direction information of the corresponding latent vector based on the selected codebook vector.

In some embodiments, the step of generating the magnitude information may comprise quantizing the magnitude of each of the at least one latent vector using a μ-law quantizer.

In some embodiments, the last activation function of the encoder neural network may comprise Tanh.

In some embodiments, the second communication device may comprise a decoder neural network that obtains a reconstruction of the first channel state information based on the second channel state information. In some embodiments, the encoder neural network and the decoder neural network may be pre-trained such that an objective function is minimized.

In some embodiments, the step of generating the direction information may comprise, for each of the at least one latent vector, selecting a codebook vector closest to the corresponding latent vector from among a plurality of codebook vectors included in a pre-configured codebook, and generating the direction information of the corresponding latent vector based on the selected codebook vector. In some embodiments, the first channel state information may comprise a channel matrix for the wireless link. In some embodiments, the objective function [symbol] may be defined by the following equation:

$${ℒ}_{VQ} = {‖ \hat{H} - {\tilde{H}}_{ad} ‖}_{F}^{2} + {‖ sg ( z ) - {z}_{q} ‖}^{2} + β {‖ z - sg ( {z}_{q} ) ‖}^{2} ,$$

wherein \tilde{H}_{ad} is the channel matrix, Ĥ is a reconstruction of the channel matrix, z is the at least one latent vector, z_{q} is a quantization result of the at least one latent vector, sg is a stop-gradient operator, and β is a pre-set coefficient. In some embodiments, the encoder neural network, the decoder neural network, and the codebook may be pre-trained such that the objective function is minimized.

In some embodiments, the first communication device may comprise a plurality of transmit antennas, the second communication device may comprise at least one receive antenna, and the channel may be an OFDM-based channel. In some embodiments, the method may further comprise: generating a spatial-frequency domain channel matrix through estimation of the channel; and transforming the spatial-frequency domain channel matrix to generate an angular-delay domain channel matrix. In some embodiments, the step of generating the at least one latent vector may comprise generating the at least one latent vector based on the generated angular-delay domain channel matrix.

In some embodiments, the step of generating the at least one latent vector may comprise: truncating the angular-delay domain channel matrix; and inputting the truncated angular-delay domain channel matrix as the first channel state information into the encoder neural network.

In some embodiments, the first communication device may comprise a base station of a mobile communication system, and the second communication device may comprise a user equipment of the mobile communication system.

According to another aspect of the present disclosure, there is provided a method in which a second communication device receives channel state information from a first communication device, the method comprising: receiving, from the first communication device, second channel state information including magnitude information and direction information corresponding to each of at least one latent vector; and inputting information based on the second channel state information into a decoder neural network to obtain a reconstruction of first channel state information—including channel state information for a wireless link from the second communication device to the first communication device.

In some embodiments, the at least one latent vector may be generated by the first communication device inputting the first channel state information into an encoder neural network.

In some embodiments, the direction information may be generated by the first communication device selecting a codebook vector closest to the corresponding latent vector from among a plurality of codebook vectors included in a pre-configured codebook, and based on the selected codebook vector.

In some embodiments, the direction information may include an identifier of the selected codebook vector. In some embodiments, the step of inputting information based on the second channel state information into the decoder neural network may comprise: for each of the at least one latent vector, based on an identifier included in the direction information of the corresponding latent vector, selecting one of a plurality of codebook vectors included in a codebook pre-configured at the second communication device as a direction vector for the corresponding latent vector; and inputting the selected direction vector into the decoder neural network.

In some embodiments, the encoder neural network and the decoder neural network may be pre-trained such that an objective function is minimized. In some embodiments, the direction information may be generated by the first communication device selecting a codebook vector closest to the corresponding latent vector from among a plurality of codebook vectors included in a pre-configured codebook, and based on the selected codebook vector. In some embodiments, the first channel state information may comprise a channel matrix for the wireless link. In some embodiments, the objective function [symbol] may be defined by the following equation:

$${ℒ}_{VQ} = {‖ \hat{H} - {\tilde{H}}_{ad} ‖}_{F}^{2} + {‖ sg ( z ) - {z}_{q} ‖}^{2} + β {‖ z - sg ( {z}_{q} ) ‖}^{2} ,$$

wherein \tilde{H}_{ad} is the channel matrix, Ĥ is a reconstruction of the channel matrix, z is the at least one latent vector, z_{q} is a quantization result of the at least one latent vector, sg is a stop-gradient operator, and β is a pre-set coefficient. In some embodiments, the encoder neural network, the decoder neural network, and the codebook may be pre-trained such that the objective function is minimized.

In some embodiments, the first communication device may comprise a base station of a mobile communication system, and the second communication device may comprise a user equipment of the mobile communication system.

According to yet another aspect of the present disclosure, there is provided a method in which at least one processor trains a machine learning model—including an encoder neural network and a decoder neural network—the method comprising: inputting first channel state information—including channel state information for a wireless link from a second communication device to a first communication device—into the encoder neural network to generate at least one latent vector; for each of the at least one latent vector, separately quantizing a magnitude and a direction of the corresponding latent vector to generate magnitude information and direction information; inputting information based on second channel state information—including the magnitude information and the direction information corresponding to each of the at least one latent vector—into the decoder neural network to obtain a reconstruction of the first channel state information; and updating parameters of the encoder neural network and parameters of the decoder neural network such that an objective function is minimized.

In some embodiments, the step of generating the direction information may comprise, for each of the at least one latent vector, selecting a codebook vector closest to the corresponding latent vector from among a plurality of codebook vectors included in a codebook, and generating the direction information of the corresponding latent vector based on the selected codebook vector. In some embodiments, the step of updating may comprise updating parameters of the encoder neural network, parameters of the decoder neural network, and the codebook. In some embodiments, the first channel state information may comprise a channel matrix for the wireless link. In some embodiments, the objective function [symbol] may be defined by the following equation:

$${ℒ}_{VQ} = {‖ \hat{H} - {\tilde{H}}_{ad} ‖}_{F}^{2} + {‖ sg ( z ) - {z}_{q} ‖}^{2} + β {‖ z - sg ( {z}_{q} ) ‖}^{2} ,$$

wherein \tilde{H}_{ad} is the channel matrix, Ĥ is a reconstruction of the channel matrix, z is the at least one latent vector, z_{q} is a quantization result of the at least one latent vector, sg is a stop-gradient operator, and β is a pre-set coefficient.

In some embodiments, the method may further comprise normalizing the plurality of code book vectors included in the codebook after the codebook is updated.

In some embodiments, the codebook may be configured with a nested codebook structure.

In some embodiments, the step of updating may comprise using soft gradient passing during backpropagation of the direction information.

In some embodiments, the first communication device may comprise a base station of a mobile communication system, and the second communication device may comprise a user equipment of the mobile communication system.

According to yet another aspect, a communication device is provided, comprising: a processor; one or more hardware-based transceivers; and a computer-readable storage medium storing instructions that, when executed by the processor, cause the communication device to perform at least one of the methods of the present disclosure.

According to yet another aspect, a non-transitory computer-readable recording medium storing instructions is provided, wherein the instructions, when executed by a processor of an electronic device, cause the processor to perform embodiments of the present disclosure.

Some embodiments of the present disclosure may have the effect of including the following advantages. However, it is not meant that all embodiments must include all of these, and accordingly, the scope of the present invention should not be construed as being limited thereby.

According to some embodiments, accurate channel state information may be provided with reduced feedback overhead.

According to some embodiments, accurate channel state information may be provided with reduced computational complexity.

The foregoing summary is provided to introduce a selection of concepts that are further described in the detailed description below in a simplified form. The summary is not intended to identify key features or essential features of the claimed subject matter, nor is it intended to be used to limit the scope of the claimed subject matter. Further, the claimed subject matter is not limited to implementations that solve some or all of the problems noted in any part of this specification. In addition to the foregoing exemplary aspects, embodiments, and features, additional aspects, embodiments, and features will become apparent by reference to the following detailed description and drawings.

### BRIEF DESCRIPTION OF THE DRAWINGS

FIG. 1 illustrates a system for describing some embodiments of the channel state information feedback of the present disclosure.

FIG. 2 is a flowchart for describing some embodiments of the channel state information feedback of the present disclosure.

FIG. 3 is a block diagram for describing a quantization process according to some embodiments.

FIG. 4 is a conceptual diagram for describing some embodiments of magnitude quantization.

FIG. 5 is a table showing performance of transformation methods used in magnitude quantization.

FIG. 6 illustrates NMSE performance of each CSI feedback method according to feedback overhead.

FIG. 7 illustrates NMSE performance of each CSI feedback method at a given complexity.

FIG. 8 illustrates performance of a CSI feedback method using a nested codebook and a CSI feedback method using a separate codebook.

FIG. 9 is a block diagram for describing the internal configuration of a computing system (or computing device) according to an embodiment of the present disclosure.

### DETAILED DESCRIPTION OF EMBODIMENTS

The following description is a structural and functional explanation for embodiments of the present invention. The scope of the present invention is not to be construed as limited to the embodiments described in the body of this specification. That is, since embodiments may be modified in various ways and may take various forms, the scope of the present invention should be understood to encompass equivalents capable of realizing the technical ideas of the present invention. In addition, since it is not meant that specific embodiments presented in the present invention must include all of the purposes or effects presented or include only such effects, the scope of the present invention is not to be construed as limited thereby.

Meanwhile, the meaning of terms described in this disclosure should be understood as follows.

Terms such as “first” and “second” are used to distinguish one component from another component, and the scope of rights is not limited by these terms. For example, a first component may be named a second component, and similarly, a second component may also be named a first component.

When it is mentioned that a component is “connected to” another component, it should be understood that it may be directly connected to the other component, or that other components may exist in between. On the other hand, when it is mentioned that a component is “directly connected to” another component, it should be understood that no other component exists in between. Meanwhile, other expressions describing the relationship between components, such as “between” and “directly between” or “adjacent to” and “directly adjacent to,” should also be interpreted in the same manner.

Unless clearly distinguished in context, a singular expression should be understood to include a plural expression, and terms such as “comprise” or “have” are intended to designate the existence of a combination of features, numbers, steps, operations, components, parts, or combinations thereof, and should be understood not to preclude the existence or additional possibility of one or more other features, numbers, steps, operations, components, parts, or combinations thereof.

Identifiers used in each step (e.g., a, b, c, etc.) are used for convenience of description, and the identifiers do not describe the order of each step; each step may occur in a different order from the stated order unless a specific order is clearly stated in context. That is, each step may occur in the same order as stated, may be performed substantially simultaneously, or may be performed in reverse order.

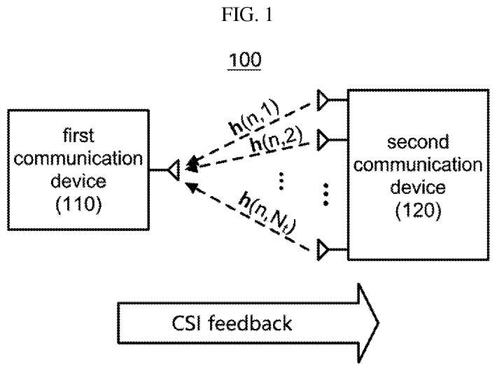

FIG. 1 illustrates a system for describing some embodiments of the channel state information feedback of the present disclosure.

In some embodiments, as illustrated in FIG. 1, a system (100) may comprise a first communication device (110) and a second communication device (120). In other embodiments, the system (100) may comprise a plurality of first communication devices (110) and second communication devices (120). In yet other embodiments, the system (100) may comprise a plurality of first communication devices (110) and a plurality of second communication devices (120).

In some embodiments, as illustrated in FIG. 1, the second communication device (120) may comprise at least one transmit antenna having a number Nₜ (as illustrated in FIG. 1), and the first communication device (110) may comprise at least one receive antenna having a number of 1 (as illustrated in FIG. 1, Nᵣ). In other embodiments, the first communication device (110) may comprise a plurality of receive antennas.

In some embodiments, the system (100) may be a cellular MIMO system comprising each first communication device (110) and each second communication device (120) as a user equipment and a base station (e.g., gNB of a 5G NR system as defined in 3GPP specification), respectively. In other embodiments, the system (100) may be a non-cellular MIMO system. For example, the system (100) may be a Wi-Fi communication system comprising each first communication device (110) and each second communication device (120) as a wireless station and a wireless access point, respectively.

In some embodiments, each first communication device (110) and each second communication device (120) may communicate with each other using an OFDM modulation scheme. In other embodiments, each first communication device (110) and each second communication device (120) may use other modulation schemes besides OFDM (e.g., CDMA).

In some embodiments, as illustrated in FIG. 1, the first communication device (110) may acquire channel state information for a wireless link from the second communication device (120) toward the first communication device (110) and transmit the acquired channel state information to the second communication device (120). In some embodiments, the channel state information may include information about each channel component of the wireless link. For example, in an OFDM-based system, as illustrated in FIG. 1, each channel component h may be characterized by a path connected to each transmit antenna and each receive antenna (in the case of FIG. 1, a single receive antenna) and each subcarrier (in FIG. 1, the n-th subcarrier).

Hereinafter, for convenience, embodiments of the present disclosure will be described primarily with reference to a single cell MIMO system using OFDM with N_{c} subcarriers, comprising a base station having Nₜ (Nₜ being a natural number of 2 or more) transmit antennas and a plurality of user equipment (UE) each having a single receive antenna (i.e., Nᵣ=1). It should be appreciated that through such description, the technique of the present disclosure can be easily applied, implemented, or reproduced in other systems as well.

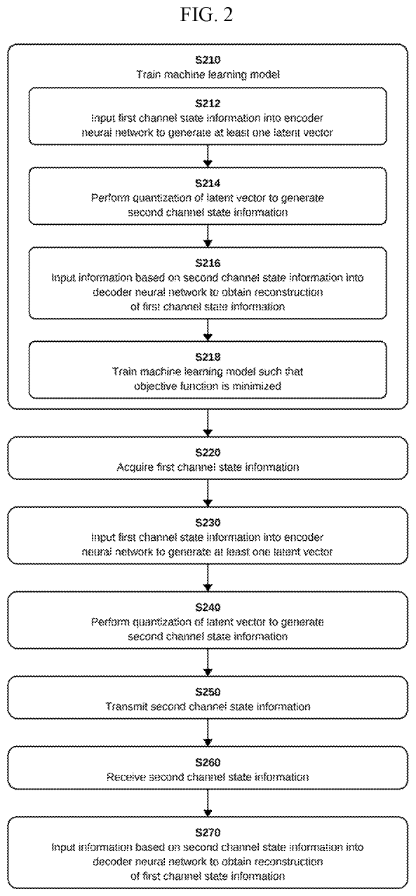

FIG. 2 is a flowchart for describing some embodiments of the channel state information feedback of the present disclosure.

In some embodiments, each block illustrated in FIG. 2 may be performed by the first communication device (110), the second communication device (120), the system (100), and/or a device operating the system (100).

In some embodiments, as illustrated in FIG. 1, a machine learning model (e.g., Deep Learning Model) may be trained (S210). For example, the first communication device (110), the second communication device (120), the system (100), or a processor included in other equipment may train the machine learning model. Accordingly, for example, trained model parameters (e.g., encoder neural network parameters, decoder neural network parameters, and codebook) may be communicated between the first communication device and the second communication device, or may be distributed from a training entity (e.g., the system (100) or other equipment) to the first communication device and the second communication device, so that each device is configured with the parameters necessary for inference.

In some embodiments, the machine learning model may comprise an encoder neural network and a decoder neural network. In other embodiments, the machine learning model may comprise an encoder neural network, a decoder neural network, and a codebook to be described later. For example, the encoder neural network and an associated quantization module (described below), which in some embodiments may use the codebook, may collectively be referred to as a CSI generation part, and the decoder neural network and an associated dequantization module (described below), which in some embodiments may use the codebook, may collectively be referred to as a CSI reconstruction part.

In some embodiments, at S210, the processor may input first channel state information into the encoder neural network to generate at least one latent vector (S212), perform quantization on at least one latent vector to generate second channel state information (S214), input information based on the second channel state information into the decoder neural network to obtain a reconstruction of the first channel state information (S216), and train the machine learning model such that an objective function is minimized (S218).

In some embodiments, the first channel state information may comprise channel state information for a wireless link from the second communication device (120) to the first communication device (110). In some embodiments, the first channel state information may be used for training of the present disclosure after being obtained in advance as a training data item at S210 (i.e., unlike S220, which will be described later).

In some embodiments, the processor may, at S214, separately quantize the magnitude and direction of each of the at least one latent vector to generate magnitude information and direction information, respectively.

In some embodiments, the second channel state information may include the magnitude information and the direction information corresponding to each of the at least one latent vector.

In some embodiments, the processor may, at S218, update parameters of the encoder neural network and parameters of the decoder neural network such that the objective function is minimized.

In some embodiments, the processor may, at S214, for each of the at least one latent vector, select a codebook vector closest to the corresponding latent vector from among a plurality of codebook vectors included in a codebook, and generate the direction information of the corresponding latent vector based on the selected codebook vector. At S218, the processor may update parameters of the encoder neural network, parameters of the decoder neural network, and the codebook such that the objective function is minimized.

In some embodiments, at S210, the processor may perform normalization of the plurality of codebook vectors included in the codebook after the codebook is updated.

In some embodiments, the codebook may be configured with a nested codebook structure.

In some embodiments, the processor may use soft gradient passing during backpropagation of the direction information at S218.

In some embodiments, as illustrated in FIG. 2, the first communication device (110) may acquire first channel state information (S220). For example, the first communication device (110) may acquire the first channel state information based on signals (e.g., pilot signals) transmitted from the second communication device (120). For example, the system may operate in a frequency division duplex (FDD) mode. In FDD mode, the uplink and downlink transmissions use different carrier frequencies, and the channel is not reciprocal between the uplink and downlink directions. Accordingly, the user equipment (UE) estimates the downlink channel state information (CSI) based on downlink reference signals (e.g., CSI-RS) transmitted by the base station, and feeds back the estimated CSI to the base station via an uplink channel.

In some embodiments, the first communication device (110) may obtain a spatial-frequency domain channel matrix through channel estimation, and use the spatial-frequency domain channel matrix as the first channel state information. In other embodiments, the first communication device (110) may transform the spatial-frequency domain channel matrix to generate an angular-delay domain channel matrix, and use the generated angular-delay domain channel matrix as the first channel state information. In yet other embodiments, the first communication device (110) may truncate the generated angular-delay domain channel matrix, and use the truncated angular-delay domain channel matrix as the first channel state information.

In some embodiments, as illustrated in FIG. 2, the first communication device (110) may input the first channel state information into the encoder neural network (e.g., the encoder neural network trained at S210) to generate at least one latent vector (S230).

In some embodiments, as illustrated in FIG. 2, the first communication device (110) may separately quantize the magnitude and direction of each of the at least one latent vector to generate magnitude information and direction information (S240).

In some embodiments, as illustrated in FIG. 2, the first communication device (110) may transmit second channel state information including the magnitude information and the direction information corresponding to each of the at least one latent vector to the second communication device (S250).

In some embodiments, at S240, the first communication device (110) may, for each of the at least one latent vector, select a codebook vector closest to the corresponding latent vector from among a plurality of codebook vectors included in a pre-configured codebook (e.g., a codebook trained at S210), and generate the direction information of the corresponding latent vector based on the selected codebook vector. In some embodiments, the direction information of the corresponding latent vector may include an identifier of the selected codebook vector.

In some embodiments, the plurality of codebook vectors may comprise unit norm vectors. In some embodiments, the first communication device (110) may, at S240, normalize each of the at least one latent vector so that its magnitude becomes 1, and for each of the normalized latent vectors, select a codebook vector closest to the corresponding normalized latent vector from among the plurality of codebook vectors, and generate the direction information of the corresponding latent vector based on the selected codebook vector.

In some embodiments, the first communication device (110) may, at S240, quantize the magnitude of each of the at least one latent vector using a μ-law quantizer.

In some embodiments, the last activation function of the encoder neural network may comprise Tanh.

In some embodiments, as illustrated in FIG. 2, the second communication device (120) may receive, from the first communication device (110), second channel state information including the magnitude information and direction information corresponding to each of the at least one latent vector (S260).

In some embodiments, as illustrated in FIG. 2, the second communication device (120) may input information based on the second channel state information into a decoder neural network (e.g., the decoder neural network trained at S210) to obtain a reconstruction of the first channel state information (S270).

In some embodiments, the second communication device (120) may, at S270, based on an identifier included in the direction information of each of the at least one latent vector, select one of a plurality of codebook vectors included in a codebook pre-configured at the second communication device (e.g., the codebook trained at S210) as a direction vector for the corresponding latent vector, and input the selected direction vector into the decoder neural network.

In some embodiments, the channel matrix H_{sf} may be formed in the spatial and frequency domain as H_{sf}ϵ [symbol] ^{N}^{_{c}}^{×N}^{ₜ}. Here, [symbol] ^{N}^{_{c}}^{×N}^{ₜ} means a complex matrix of size N_{c}×Nₜ.

In some embodiments, this channel matrix H_{sf} may be directly input to the machine learning of the present disclosure and used in the CSI feedback manner.

In other embodiments, a channel matrix (e.g., an angular-delay domain matrix) of a different type from the channel matrix H_{sf} may be directly input to the machine learning of the present disclosure and used in the CSI feedback manner. For example, in massive-MIMO, when the number of scatter clusters is much smaller than the number of base station transmit antennas, the channel matrix H_{sf} may be transformed to a sparse matrix in the angular-delay domain.

In some embodiments, the channel matrix H_{sf} may be transformed to the angular-delay domain channel matrix H_{ad} through a two-dimensional Discrete Fourier Transform (hereinafter DFT) as shown in Equation 1: H_{ad}=F_{d}H_{sf}Fₐ, where F_{d} and Fₐ are DFT matrices of size N_{c}×N_{c} and Nₜ×Nₜ, respectively.

In some embodiments, all components contained in the channel matrix H_{ad} may be directly input to the machine learning of the present disclosure and used in the CSI feedback manner.

In other embodiments, only some of the components contained in the channel matrix H_{ad} may be directly input to the machine learning of the present disclosure and used in the CSI feedback manner. For example, since multipath delays may be confined to a limited time interval, only the first Ñ_{c}(<N_{c}) delay components from the front of the angular-delay domain channel matrix H_{ad} may contain significant or important values. In this case, by applying truncation to H_{ad}, a truncated channel matrix \tilde{H}_{ad}ϵ [symbol] ^{Ñ}^{_{c}}^{×N}^{ₜ} representing the top Ñ_{c} rows of H_{ad} may be generated. This truncated channel matrix \tilde{H}_{ad} may be represented as a matrix of size (2×Ñ_{c})×Nₜ providing real number input values to the network model.

In some embodiments, the truncated channel matrix \tilde{H}_{ad} may be compressed and quantized for transmission at the user equipment.

In some embodiments, the truncated channel matrix \tilde{H}_{ad} may be compressed to a full latent vector zϵ [symbol] ^{M(=N×D)}. This full latent vector may be expressed by Equation 2: z=ƒ_{enc}(\tilde{H}_{ad}), where ƒ_{enc} represents the encoder neural network. The full latent vector z may include N latent vectors (also referred to as latent sub-vectors), each having dimension D. The compression of channel state information into a latent representation via the encoder neural network may also be referred to as AI/ML-based CSI compression.

In some embodiments, the full latent vector z may be quantized, and a quantized vector z_{q} located in the embedding space may be generated.

In some embodiments, upon receiving the quantized vector z_{q} as feedback from the user equipment, the base station may derive a reconstruction Ĥ of the channel matrix \tilde{H}_{ad} based on z_{q}. The reconstruction process may be expressed by Equation 3: Ĥ=ƒ_{dec}(z_{q}), where ƒ_{dec} represents the decoder neural network.

In some embodiments, the system may perform generation and quantization of latent vectors and reconstruction of channel matrices through the machine learning model. For example, the system may apply the VQ-VAE (Vector Quantized Variational Autoencoder) technique, used for image data compression transmission in the paper by A. van den Oord, O. Vinyals, and K. Kavukcuoglu, “Neural discrete representation learning,” Adv. Neural Inf. Process. Syst., December 2017, pp. 6306-6315, to channel state information transmission.

In some embodiments, the system may include an encoder and a decoder of typical autoencoder models, and a quantization module. The quantization module may be positioned at the encoder, at the decoder, or between the encoder and the decoder. In some embodiments, the quantization module may use a codebook. In some embodiments, the codebook may be trained. As described above, trained model parameters including the codebook may be communicated between the first communication device and the second communication device. In some embodiments, the second communication device may transmit codebook configuration information to the first communication device to configure the AI/ML-based CSI compression using the quantization method disclosed herein.

For convenience in this specification, the codebook is represented as set [symbol] , and the codebook [symbol] comprises KD-dimensional codebook vectors

$$( i . e . , {\{ {b}_{k} \}}_{k = 1}^{K} ) .$$

In some embodiments, the quantization module may need to perform quantization of the N latent vectors

$${\{ {z}_{i} \}}_{i = 1}^{N}$$

within one codebook when the total dimension of the full latent vector is N×D, where zᵢ=[z_{(i-1)D+1}, . . . , z_{iD}].

In some embodiments, each of the latent vectors may be quantized to the closest vector within the codebook, as shown in Equation 4:

$${z}_{q , i} = arg {min}_{{b}_{k}} ‖ {z}_{i} - {b}_{k} ‖$$

with iϵ{1, . . . , N}. In Equation 4, z_{q,i} represents the quantized result of latent vector zᵢ.

In some embodiments, the objective function of the machine learning model may be expressed by Equation 5:

$${ℒ}_{VQ} = {‖ \hat{H} - {\tilde{H}}_{ad} ‖}_{F}^{2} + {‖ sg ( z ) - {z}_{q} ‖}^{2} + β {‖ z - sg ( {z}_{q} ) ‖}^{2} .$$

In Equation 5, sg(⋅) represents the stop-gradient operator that ignores gradient descent computation. In Equation 5, the first and second terms represent the reconstruction loss and the codebook loss, respectively, and the third term is a commitment loss regularized by a coefficient β set to a value between 0.1 and 2.0.

In some embodiments, after the quantization errors corresponding to the second and third terms of Equation 5 are calculated, gradient correction for the decoder input may be performed using z_{q}←z+sg(z_{q}−z). This prevents the reconstruction loss term from being affected by quantization errors.

In some embodiments, by constructing the loss structure as described above, the system may update the codebook, encoder, and decoder in a heuristic manner.

In some embodiments, the system may, through the above-described VQ-VAE for CSI feedback, when performing exhaustive quantization search of the VQ-VAE, separate the spatial characteristics of the latent vector into magnitude and direction for quantization. For example, the system may perform magnitude quantization (Q_{mag}) and direction quantization (Q_{dir}) for each latent vector zᵢ, as shown in Equation 6: z_{q,i}=Q_{mag}(∥zᵢ∥)·Q_{dir}(\tilde{z}ᵢ) where \tilde{z}ᵢ=zᵢ/∥zᵢ∥ to generate a quantized latent vector z_{q,i}.

For example, the magnitude information and direction information obtained through magnitude quantization and direction quantization for each latent vector zᵢ may be configured with B_{mag} bits and B_{dir} bits, respectively, and the number of bits B used to transmit the quantized latent vector z_{q,i} is B_{mag}+B_{dir}. Here, B_{mag} and B_{dir} may have pre-set natural number values.

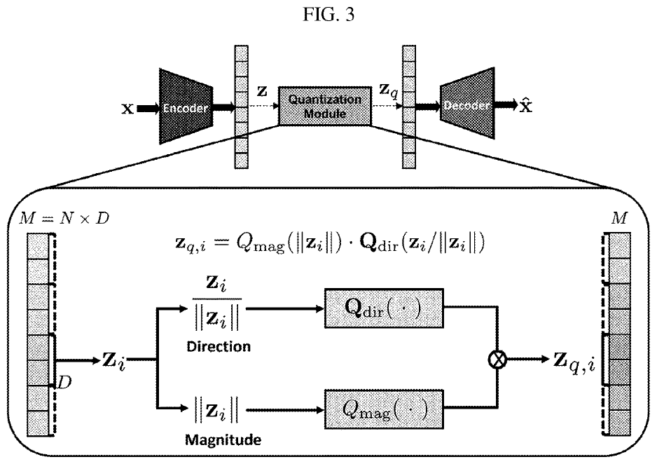

FIG. 3 is a block diagram for describing a quantization process according to some embodiments.

In some embodiments, the system may use a uniform quantizer expressed by the function ƒ_{quan}(x) in Equation 7 to quantize the magnitude of each latent vector:

$${f}_{quan} ( x ) = \frac{round ( {2}^{{B}_{mag}} x - 0.5 ) + 0.5}{{2}^{{B}_{mag}}} ,$$

for 0≤x≤1.

In some embodiments, the system may use Tanh as the last activation function of the encoder. In this case, each of the N latent vectors zᵢ may have a magnitude bounded by \sqrt{D}.

In some embodiments, when the magnitude of each latent vector does not have a value in the [0,1] range, the system may perform preprocessing on each latent vector so that the magnitude of each latent vector has a value in the [0, 1] range before applying the uniform quantization exemplified by Equation 7.

For example, the system may normalize each latent vector by dividing by \sqrt{D}.

As another example, the system may quantize the magnitude of each latent vector using transformation functions as exemplified by Equations 8 through 10. For example, the system may apply a transformation function to the magnitude of each latent vector, then apply a uniform quantizer, and perform quantization. For example, when using Equations 8 and 9 as transformation functions, the magnitude quantization may be expressed as Q_{mag}(∥zᵢ∥)=h⁻¹(ƒ_{quan}(h(∥zᵢ∥))) and Q_{mag}(∥zᵢ∥)=h_{μ-law}⁻¹(ƒ_{quan}(h_{μ-law}(∥zᵢ∥))), respectively.

In one embodiment, the transformation function may be the cumulative distribution function (CDF) of ∥zᵢ∥, defined by Equation 8: h(x)=F_{∥z}_{ᵢ}_{∥}(x), and this CDF may be obtained through training data.

In another embodiment, the transformation function may be the μ-law transformation function defined by Equation 9:

$${h}_{μ - law} ( x ) = \frac{ln ( 1 + μ \frac{x}{\sqrt{D}} )}{ln ( 1 + μ )}$$

for 0≤x≤\sqrt{D}. For example, the μ-law quantizer may be effectively applied to a system that tends to concentrate magnitudes near values close to 0. The constant in Equation 9 may be a pre-set positive constant.

In yet another embodiment, the transformation function may be the clipped μ-law transformation function defined by Equation 10:

$${\hat{h}}_{μ - law} ( x ) = \{ \begin{matrix}{h}_{μ - law} ( x ) , & 0 \leq x \leq \frac{{( 1 + μ )}^{A} - 1}{μ} \\ A , & \frac{{( 1 + μ )}^{A} - 1}{μ} < x \leq \sqrt{D}\end{matrix}$$

The constant A in Equation 10 may be a pre-set positive constant. When using the clipped μ-law function, the magnitude values may have a range of [0, A].

In some embodiments, when the system uses the clipped μ-law transformation function, it may use the uniform quantizer expressed by Equation 11 instead of Equation 7:

$${\hat{f}}_{quan} ( x ) = A \{ \frac{round ( {2}^{{B}_{mag}} x / A - 0.5 ) + 0.5}{{2}^{{B}_{mag}} - 1} \} , for 0 \leq x \leq A$$

In some embodiments, the system may use soft gradient passing. For example, soft gradient passing may be applied to a system in which the round function itself causes a zero gradient problem (e.g., a system using Equation 7 or Equation 11). In some embodiments, the system may, when performing backpropagation only, replace the round functions with step-wise tanh functions so that grad grad Q_{mag}(∥zᵢ∥)=grad h⁻¹(\tilde{ƒ}_{quan}(h(∥zᵢ∥))) is achieved. For example, in the case of Equation 11, \tilde{f}_quan(x) may be expressed by Equation 12:

$${\tilde{f}}_{quan} ( x ) = \frac{A}{2} \{ \frac{{\sum }_{i = 1}^{{2}^{{B}_{mag} - 1}} tanh ( τ ( {2}^{{B}_{mag}} - 1 ) x / A - i ) ) + 1}{{2}^{{B}_{mag}} - 1} \}$$

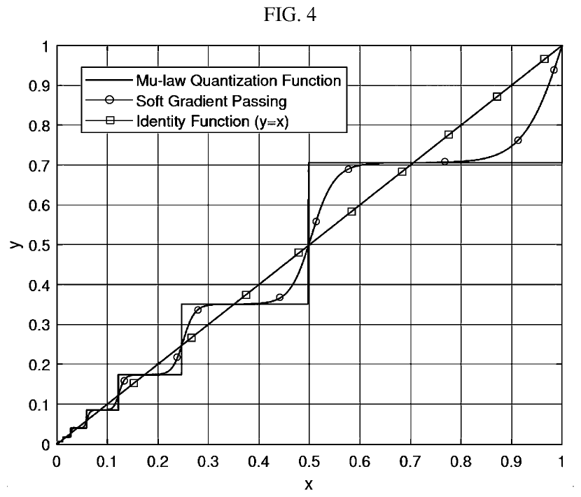

FIG. 4 is a conceptual diagram for describing some embodiments of magnitude quantization. FIG. 4 shows curves for the identity function, the μ-law quantization function, and the soft gradient passing, each related to Q_{mag}(∥zᵢ∥). According to the embodiment of FIG. 4, the quantization result may be expressed as 3 bits (i.e., B_{mag}=3).

In some embodiments, the system may use a trainable codebook as the direction quantizer. In some embodiments, the system may train the codebook by: initializing the codebook so that it satisfies certain conditions; and updating the codebook through stochastic gradient descent of a loss function.

In some embodiments, assuming that the directions of the latent vectors are uniformly distributed, the system may initialize the codebook vectors

$$( {\{ {b}_{k} \}}_{k = 1}^{K} )$$

as a Grassmannian codebook that optimizes the codebook vectors in D-dimensional real space based on Equation 13:

$${min}_{ℬ , {b}_{i} ∈ {ℝ}^{D}} {max}_{i \neq j} \vert {b}_{i}^{H} {b}_{j} \vert$$

In some embodiments, the codebook may be composed of unit norm vectors. In some embodiments, the system may normalize each codebook vector after updating the codebook so that each codebook vector becomes a unit norm vector. For example, since the vectors of the codebook may not have unit norm after a gradient descent update, the system may perform normalization of the codebook vectors after the codebook update. In some embodiments, this normalization process may not be included in the gradient computation.

In some embodiments, the system may use the direction quantization rule of Equation 14:

$${Q}_{dir} ( {\tilde{z}}_{i} ) = {arg min}_{{b}_{k} ∈ ℬ} d ( {\tilde{z}}_{i} , {b}_{k} ) .$$

In Equation 14, d( ) represents the distance between two unit norm vectors c₁ and c₂. For example, d( ) may be measured by the sine of the angle between the two unit norm vectors, and may be defined by Equation 15: d(c₁, c₂)=\sqrt{1−|c₁, c₂|²}.

In some embodiments, the system may, similarly to VQ-VAE, calculate quantization errors and then perform gradient correction using Equation 16: z_{q,i}←zᵢ+sg(z_{q,i}−zᵢ). For example, this prevents the reconstruction loss term from being affected by quantization errors.

In some embodiments, the system may extend the above-described embodiments to multi-rate codebook design.

In some embodiments, the system may construct the codebook in a nested fashion so that the size can be adjusted by the user according to the situation, expressed as [symbol] ⁽¹⁾⊂ [symbol] ⁽²⁾⊂ . . . ⊂ [symbol] ^{(L)}, where

$${K}_{j} = \vert {ℬ}^{( j )} \vert = {2}^{{B}_{dir}^{( j )}} ( j = 1 , 2 , … , L ) , and {B}_{dir}^{( j )}$$

represents the number of bits for the codebook vectors of the j-th codebook.

In some embodiments, the system may train the L nested codebooks in a step-by-step manner. In some embodiments, the system may initialize and train the first codebook [symbol] ⁽¹⁾ in the manner described above. In some embodiments, for j(>1)-th codebook, the system may initialize [symbol] ⁽ⁱ⁾ by randomly adding Kⱼ−Kⱼ₋₁ vectors to the (j−1)-th codebook [symbol] ^{(j-1)}, and train the codebook according to the loss function of Equation 17:

$${ℒ}_{NVQ}^{( j )} = \frac{1}{{\sum }_{k = 1}^{j} {γ}^{k}} {\sum }_{i = 1}^{j} {γ}^{i} ( {‖ {\hat{H}}^{( i )} - {\tilde{H}}_{ad} ‖}_{F}^{2} + {‖ sg ( z ) - {z}_{q}^{( i )} ‖}^{2} + β {‖ z - sg ( {z}_{q}^{( i )} ) ‖}^{2} )$$

where

$${z}_{q}^{( i )}$$

is the full latent vector quantized with codebook

$${ℬ}^{( i )} , {\hat{H}}^{( i )} = {f}_{dec} ( {z}_{q}^{( i )} ) ,$$

and γ is a hyperparameter that controls the portion of each quantization order's loss in the nested codebook.

Some embodiments using magnitude quantization and direction quantization are referred to as the Shape-Gain method, and simulation results are compared with the original VQ-VAE method as a benchmark. Here, the Shape-Gain method refers to the CSI feedback method using direction quantization and magnitude quantization, respectively, and the original VQ-VAE method refers to the CSI feedback method based on the paper by A. van den Oord et al.

In some embodiments, the codebook configuration information may be transmitted via Radio Resource Control (RRC) signaling. The codebook configuration information may be included in an RRC information element (IE), for example, as part of an existing CSI report configuration IE (e.g., CSI-ReportConfig as defined in 3GPP TS 38.331) or as a new IE dedicated to AI/ML-based CSI compression configuration. The codebook configuration information may comprise one or more of the following fields:
(a) Direction Codebook Configuration: A direction codebook configuration field may indicate a direction codebook comprising a plurality of codebook vectors (e.g., unit-norm codebook vectors) for quantizing directions of latent vectors. The direction codebook may be indicated by at least one of: an explicit set of codebook vectors (e.g., a list of K codebook vectors in D-dimensional real space, transmitted as quantized floating-point values); a pre-defined codebook identifier (e.g., an integer index referencing a codebook stored at both the second communication device and the first communication device); codebook generation parameters (e.g., a codebook dimension parameter Dϵ{8, 16, 32} together with a codebook size parameter Kϵ{64, 128, 256, 512, 1024}); or parameters specifying a segment size of the vector quantization (e.g., segment sizeϵ{4, 8, 16, 32}) and a codebook size (e.g., Kϵ{16, 64, 256, 1024, 4096}).
(b) Magnitude Quantization Configuration: A magnitude quantization configuration field may indicate parameters for quantizing magnitudes of latent vectors. The magnitude quantization configuration may comprise one or more of: a number of quantization bits allocated to magnitude quantization (e.g., B_{mag}ϵ{2, 3, 4, 5, 6}); a quantization type indicator indicating one of: uniform quantization or non-uniform quantization (e.g., μ-law companding quantization or clipped μ-law companding quantization); and for non-uniform quantization, a companding parameter (e.g., μϵ{31, 63, 127, 255, 511}) and/or a clipping parameter (e.g., Aϵ{0.1, 0.16, 0.2, 0.3, 0.5, 0.6}).
(c) Latent Vector Dimensionality: A latent vector dimensionality parameter may indicate the total dimension M=N×D of the latent representation, where N is the number of latent vectors and D is the dimension of each latent vector. For example, Nϵ{64, 128, 256, 512} and Dϵ{8, 16, 32}. Alternatively, the dimensionality may be indicated by a single parameter Mϵ{512, 1024, 2048, 4096, 8192}.

In some embodiments, the codebook configuration information may be transmitted as part of an RRCReconfiguration message, an RRCSetup message, or a dedicated signaling message for AI/ML CSI configuration. The first communication device, upon receiving the codebook configuration information, may configure its CSI generation part and quantization module accordingly, and generate CSI reports (i.e., second channel state information) based on the configured codebook and quantization parameters.

In some embodiments, the second communication device may transmit updated codebook configuration information to the first communication device in response to one or more of: a change in channel conditions (e.g., a detected decrease in CSI reconstruction quality below a threshold), a change in allocated feedback overhead (e.g., a change in the number of uplink resources available for CSI feedback), or a model update event (e.g., when a retrained model with an updated codebook is deployed).

In some embodiments, the codebook configuration information may be associated with a pairing identifier (pairing ID). The pairing ID may be an integer value (e.g., pairing IDϵ{0, 1, . . . , 255}) that associates a trained CSI generation part, a CSI reconstruction part, and a corresponding codebook. The same pairing ID may be usable for one or more of the following purposes: for the first communication device to collect target CSI for training; for applicability inquiry and reporting; for inference configuration; and for data collection by the second communication device.

In some embodiments, the trained model parameters communicated between the first communication device and the second communication device may include the codebook configuration information described above, such that the parameters specifying at least one of: a segment size of vector quantization, a codebook size, a quantization type, or a latent vector dimensionality are encompassed within the trained model parameters. The trained model parameters may also be associated with the pairing identifier described above. In some embodiments, the model pairing procedure may comprise: (1) the second communication device transmitting the pairing ID to the first communication device; (2) the first communication device selecting or activating a CSI generation part associated with the pairing ID from among a plurality of pre-stored models, the selected CSI generation part being configured to produce latent vectors compatible with the codebook associated with the pairing ID; and (3) upon successful model activation, the first communication device transmitting an acknowledgment. If model activation fails, the first communication device may transmit a negative acknowledgment, and the system may fall back to legacy CSI feedback (e.g., Type I or Type II codebook-based CSI feedback).

In some embodiments, the CSI report generated by the first communication device based on the codebook configuration information may follow a CSI Part 1/Part 2 structure. CSI Part 1 may include at least one of: a channel quality indicator (CQI) for a first codeword, a rank indicator (RI), or information representing the Part 2 size. CSI Part 2 may include the content of the CSI generation part output. The content of the CSI generation part output may comprise at least one of: the magnitude information or the direction information for each of the latent vectors. In some embodiments, the direction information for each latent vector in CSI Part 2 may include an identifier of the selected codebook vector from the pre-configured codebook.

In some embodiments, the first communication device may transmit device capability information to the second communication device indicating support for AI/ML-based CSI compression. The device capability information may be transmitted via an RRC message (e.g., UECapabilityInformation message) in response to a capability enquiry (e.g., UECapabilityEnquiry message) from the second communication device.

In some embodiments, the device capability information for AI/ML-based CSI compression may comprise at least one of: a supported latent vector dimensionality (e.g., supported combinations of N and D); a supported magnitude quantization bit depth (e.g., supported values of B_{mag}); a supported direction codebook size (e.g., supported values of K); an indication of whether the first communication device supports two-stage quantization in which a codebook vector index and a scalar magnitude value are separately generated for each latent vector; an indication of whether the first communication device supports a nested codebook structure; or a maximum total feedback overhead in bits.

In some embodiments, based on the device capability information, the second communication device may determine a CSI reporting configuration for the first communication device, specifying at least one of: the codebook to be used, the number of magnitude quantization bits, and a reporting periodicity or triggering condition for AI/ML-based CSI reports.

In some embodiments, the second communication device may dynamically signal a codebook level selection to the first communication device via downlink control information (DCI), a MAC control element (CE), or an RRC message. The feedback overhead indication may specify one of L codebook levels (e.g., L=5 levels with K₁=64, K₂=128, K₃=256, K₄=512, K₅=1024 codebook vectors). The first communication device, upon receiving the feedback overhead indication, may use the codebook at the specified level for direction quantization of latent vectors.

In some embodiments, the feedback overhead indication may be dynamically determined by the second communication device based on at least one of: a channel quality metric; an available uplink resource; or a mobility state of the first communication device.

In some embodiments, the number of magnitude quantization bits B_{mag} may also be adjusted in accordance with the specified codebook level, such that both the magnitude quantization precision and/or the direction quantization precision vary with the feedback overhead.

In some embodiments, alignment of the quantization/dequantization method and the feedback message size between the first communication device and the second communication device is performed to ensure interoperable CSI compression. For a vector quantization scheme, the alignment may include aligning a format and a size of a vector quantization (VQ) codebook, and a size and segmentation method of the CSI generation part output. For a scalar quantization scheme, the alignment may include aligning a quantization granularity comprising a distribution of bits assigned to each element. The quantization alignment may be achieved through at least one of: a model pairing process; or alignment based on a standardized quantization scheme. Additional alignment methods are not precluded.

The channel data set for the simulation was generated in an outdoor semi-urban scenario at 300 MHz using the COST2100 model. The base station was equipped with a uniform linear array with Nₜ=32 and N_{c}=1024 in the spatial-frequency domain. After transformation to the angular-delay domain, the CSI image was truncated with Ñ_{c}=32 to obtain the truncated channel matrix \tilde{H}_{ad}. This matrix is a real-valued matrix of size 2×32×32, provided as real number input. The data set comprised training, validation, and test data sets of sizes 100,000, 30,000, and 20,000, respectively. The batch size was set to 200.

Simulation parameters were set as A=0.16, B_{mag}=4, D=16, μ=255, β=0.25, and τ=8. The Adam optimizer was used with a learning rate of 0.001, and models were trained for 1000 epochs. In particular, nested codebooks were trained for 200 epochs per level.

For analyzing the performance of each method, the normalized mean squared error (NMSE) between the original channel matrix \tilde{H}_{ad} and the reconstructed channel matrix Ĥ was used, defined by Equation 18:

$$NMSE = 𝔼 \{ \frac{{‖ {\tilde{H}}_{ad} - \dot{H} ‖}_{F}^{2}}{{‖ {\tilde{H}}_{ad} ‖}_{F}^{2}} \}$$

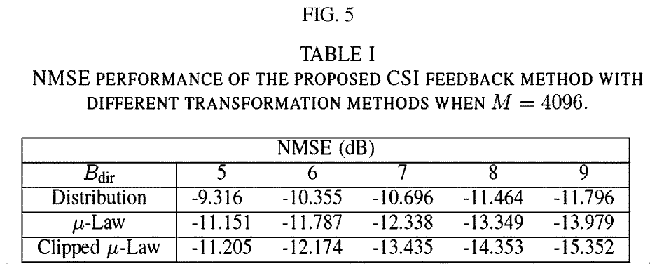

FIG. 5 is a table showing performance of transformation methods used in magnitude quantization. The table in FIG. 5 shows NMSE performance when the total latent vector dimension is M=4096. Referring to FIG. 5, even though the distribution transformation is optimal in terms of quantization perplexity, the NMSE performance shows that the clipped μ-law transformation method is generally the best overall.

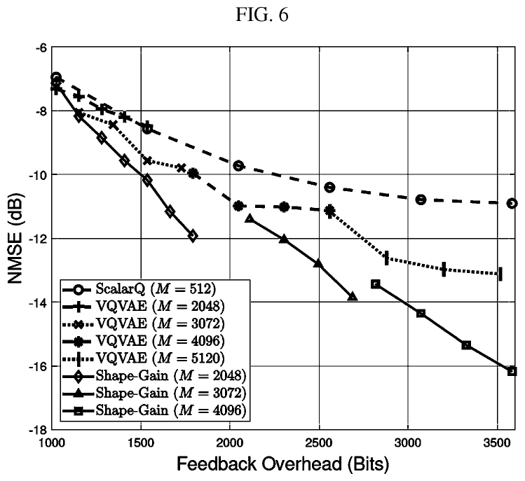

The following FIGS. 6 through 8 show simulation results when the clipped μ-law transformation method was used for magnitude quantization.

FIG. 6 illustrates NMSE performance of each CSI feedback method according to feedback overhead. In FIG. 6, the ScalarQ method represents a CSI feedback method that does not use vector quantization. Because the ScalarQ method has relatively much more feedback overhead when given the same latent dimension M compared to methods using VQ (i.e., the original VQ-VAE method and Shape-Gain method), the M of the ScalarQ method in FIG. 6 was set so that it could have a similar level of feedback overhead. Referring to FIG. 6, the Shape-Gain method shows the best performance.

To compare the complexity of quantization modules between the original VQ-VAE method and the Shape-Gain method, the number of multiplications in the quantization process may be considered. Letting B_{mag} and B_{dir} denote the number of bits for magnitude information and direction information, respectively, in the Shape-Gain method, the complexity of the Shape-Gain method's quantization process is of order O(2^{min{B}^{_{mag}}^{,B}^{_{dir}}^{}}), while the original VQ-VAE method's quantization process has complexity of order O(2^{B}), where B=B_{mag}+B_{dir}.

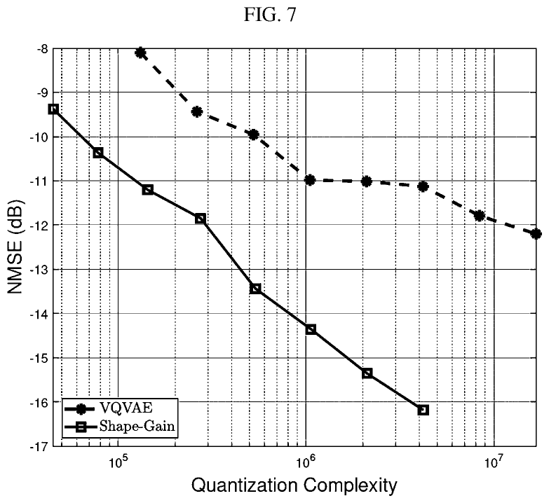

FIG. 7 illustrates NMSE performance of each CSI feedback method at a given complexity. Referring to FIG. 7, the Shape-Gain method achieves the same NMSE performance with lower complexity.

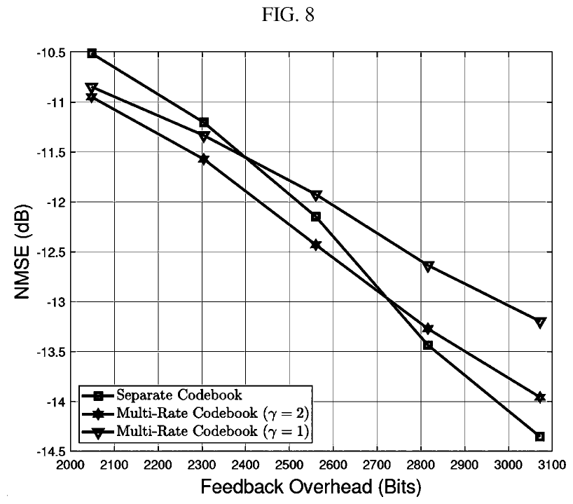

FIG. 8 illustrates performance of a CSI feedback method using a nested codebook and a CSI feedback method using a separate codebook. In the simulation of FIG. 8, the parameters M=4096, L=5,

$$\{ {B}_{dir}^{( 1 )} , {B}_{dir}^{( 2 )} , … , {B}_{dir}^{( 5 )} \} = \{ 4 , 5 , … , 8 \}$$

were used. Referring to FIG. 8, the method using the nested codebook may be superior to the method using a separate codebook. This suggests that the nested codebook training method positions the direction codebook vectors effectively in the latent space.

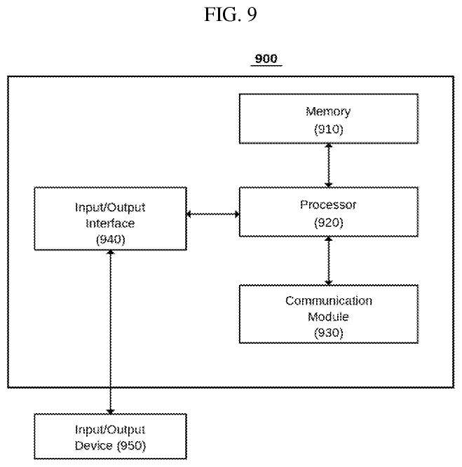

FIG. 9 is a block diagram for describing the internal configuration of a computing system (or computing device) according to an embodiment of the present disclosure. In FIG. 9, the system (900) is described as a single physical device, but in practice, the system (900) may be implemented in a linked form of multiple devices.

Such a system (900) may comprise, as illustrated in FIG. 9, a memory (910), a processor (920), a communication module (930), and an input/output interface (940). The memory (910) may include computer-readable recording media such as RAM, ROM, and permanent mass storage devices such as disk drives. The memory (910) may also include separate permanent storage separated from the memory (910). The memory (910) may also store an operating system and at least one program code (e.g., a computer program for implementing the embodiments of the present disclosure) that is stored in the recording medium to control the system (900).

The processor (920) may be configured to process basic arithmetic, logic, and input/output operations by executing instructions of a computer program. Instructions may be provided to the processor (920) by the memory (910) or the communication module (930). For example, the processor (920) may be configured to execute instructions received according to program code loaded in the memory (910). More specifically, the processor (920) may execute a computer program loaded in the memory (910) sequentially to perform the method of channel state information feedback and/or machine learning model training according to embodiments of the present disclosure.

The communication module (930) may provide functionality for communicating with other physical devices through a computer network. For example, the processor (920) of the system (900) may perform some processes of the present embodiment and exchange processing results with other physical devices (e.g., another computing system) of the network through the computer network and the communication module (930).

The input/output interface (940) may be a means for interfacing with an input/output device (950). For example, the input device may include a keyboard or a mouse, and the output device may include a display or a speaker. In FIG. 9, the input/output device (950) is shown as a separate device from the system (900), but in practice, the input/output device (950) may be implemented to be included in the system (900).

The devices described above may be implemented as hardware components, software components, and/or a combination of hardware components and software components. For example, the devices and components described in the embodiments may be implemented using one or more general-purpose or special-purpose computers. The processing device may perform one or more software applications on an operating system (OS). The processing device may also access, store, manipulate, process, and generate data in response to software execution. A processing device is described as one being used for convenience of understanding in the relevant technical field, but those skilled in the art will appreciate that a processing device may comprise a plurality of processing elements and/or a plurality of types of processing elements. For example, a processing device may comprise a plurality of processors or one processor and one controller. Also, other processing configurations such as a parallel processor are possible.

Software may comprise a computer program, code, instructions, or a combination of one or more of these, and may configure a processing device to operate independently or collectively as desired, or may command a processing device. Software and/or data may be interpreted by or provide instructions or data to a processing device through any type of machine, component, physical device, computer storage medium, or device. Software may be distributed over networked computer systems and stored or executed in a distributed manner. Software and data may be stored on one or more computer-readable recording media.

Methods according to embodiments may be performed through program instructions that can be executed by various computer means and recorded on computer-readable media. The media may continuously store a computer-executable program, or may temporarily store the program for execution or download. Also, the media may be a single or plural hardware-combined recording or storage means of various forms, not limited to media directly connected to any computer system, and may be distributed on a network. Examples of media include magnetic media such as hard disks, floppy disks, and magnetic tapes, optical recording media such as CD-ROM and DVD, magneto-optical media such as floptical disks, and ROM, RAM, flash memory, and the like configured to store program instructions. Also, other examples of media may include app stores distributing applications, sites or servers supplying or distributing various software, and recording media managed by them.

Although the above embodiments have been described with reference to limited embodiments and drawings, various modifications and changes are possible from the above description by those having ordinary skill in the relevant technical field. For example, the described techniques may be performed in a different order from the described method, and/or the described components of systems, structures, devices, circuits, etc. may be combined or arranged in a different form from the described method, or replaced or substituted by other components or equivalents to achieve appropriate results.

What is claimed is:

1. A method for a first communication device to transmit channel state information to a second communication device, the method comprising:
using an encoder neural network to generate at least one latent vector from first channel state information, the first channel state information including channel state information for a wireless link from the second communication device to the first communication device;
for each of the at least one latent vector, separately quantizing a magnitude and a direction of the corresponding latent vector to generate magnitude information and direction information; and
transmitting, to the second communication device, second channel state information including the magnitude information and the direction information corresponding to each of the at least one latent vector.

2. The method of claim 1, wherein the generating of the direction information comprises:
for each of the at least one latent vector, selecting a codebook vector closest to the corresponding latent vector from among a plurality of codebook vectors included in a pre-configured codebook, and generating the direction information of the corresponding latent vector based on the selected codebook vector.

3. The method of claim 1, wherein the generating of the magnitude information comprises quantizing a magnitude of each of the at least one latent vector using a μ-law quantizer.

4. The method of claim 1, wherein:
the second communication device comprises a decoder neural network configured to obtain a reconstruction of the first channel state information based on the second channel state information, and
the encoder neural network and the decoder neural network are pre-trained such that an objective function is minimized.

5. The method of claim 2, wherein the pre-configured codebook is configured with a nested codebook structure.

6. The method of claim 1, further comprising:
generating a spatial-frequency domain channel matrix through estimation of the wireless link; and transforming the spatial-frequency domain channel matrix to generate an angular-delay domain channel matrix,
wherein the generating of the at least one latent vector comprises generating the at least one latent vector based on the angular-delay domain channel matrix.

7. The method of claim 6, wherein the generating of the at least one latent vector comprises:
truncating the angular-delay domain channel matrix; and
inputting the truncated angular-delay domain channel matrix as the first channel state information into the encoder neural network.

8. The method of claim 1, wherein:
the first communication device comprises a user equipment of a mobile communication system,
and the second communication device comprises a base station of the mobile communication system.

9. A method for a first communication device to transmit channel state information to a second communication device, the method comprising:
using an encoder neural network to generate at least one latent vector from first channel state information, the first channel state information including channel state information for a wireless link from the second communication device to the first communication device;
for each of the at least one latent vector, selecting a codebook vector closest to the corresponding latent vector from among a plurality of codebook vectors included in a pre-configured codebook to generate an identifier of the selected codebook vector;
and transmitting, to the second communication device, second channel state information including the identifier of the selected codebook vector corresponding to each of the at least one latent vector.

10. The method of claim 9, further comprising, for each of the at least one latent vector, quantizing a magnitude of the corresponding latent vector to generate magnitude information,
wherein the identifier of the selected codebook vector represents direction information of the corresponding latent vector, and the second channel state information further includes the magnitude information.

11. The method of claim 9, wherein the pre-configured codebook is based on trained model parameters communicated between the first communication device and the second communication device.

12. The method of claim 11, wherein the trained model parameters include at least one of:
parameters specifying a segment size of vector quantization and a codebook size;
a quantization configuration indicating at least one of a number of quantization bits or a quantization type; or
a latent vector dimensionality parameter.

13. The method of claim 11, wherein the trained model parameters are associated with a pairing identifier, the pairing identifier being usable for at least one of:
collection of target CSI for training; applicability inquiry and reporting;
inference configuration; or
data collection by the second communication device.

14. The method of claim 9, wherein the second channel state information is carried in a CSI report comprising a Part 1 including at least a channel quality indicator, a rank indicator, and information representing a size of a Part 2, and the Part 2 including the identifier of the selected codebook vector.

15. The method of claim 9, further comprising transmitting, to the second communication device, device capability information indicating support for machine learning-based channel state information compression.

16. The method of claim 15, further comprising receiving, from the second communication device, a CSI reporting configuration determined based on the device capability information.

17. The method of claim 9, further comprising:
receiving, from the second communication device, a feedback overhead indication specifying a codebook level of a nested codebook structure, wherein the nested codebook structure comprises a plurality of codebook levels in which a codebook at a lower level is a proper subset of a codebook at a higher level; and
generating the identifier of the selected codebook vector using the codebook at the specified codebook level of the pre-configured codebook.

18. The method of claim 9, wherein alignment of a quantization and dequantization configuration between the first communication device and the second communication device is performed through at least one of a model pairing process or alignment based on a standardized quantization scheme.

19. A method for a second communication device to receive channel state information from a first communication device, the method comprising:
transmitting, to the first communication device, trained model parameters including a codebook for machine learning-based channel state information compression; and
receiving, from the first communication device, second channel state information generated based on the codebook, the second channel state information including an identifier of a codebook vector selected from the codebook corresponding to each of at least one latent vector.

20. The method of claim 19, further comprising: obtaining a reconstruction of first channel state information by inputting information based on the second channel state information into a decoder neural network, the first channel state information including channel state information for a wireless link from the second communication device to the first communication device.
